(19) United States
(12) Patent Application Publication
(10) Pub. No.: US 2014/0151596 A1
(43) Pub. Date: Jun. 5, 2014

(54) THERMALLY CONDUCTIVE, CORROSION RESISTANT COATINGS

(71) Applicant: ENERGYGUARD ATLANTIC, LLC, New York, NY (US)

(72) Inventor: Marc Hirsch, Roanoke, VA (US)

(21) Appl. No.: 14/094,472

(22) Filed: Dec. 2, 2013

Related U.S. Application Data
(60) Provisional application No. 61/731,526, filed on Nov. 30, 2012.

(51) Int. Cl. C09D 5/26

(52) U.S. Cl. CPC C09D 5/26
USPC 252/75; 252/77

(57) ABSTRACT

A thermally conductive, corrosion resistant coating composition for use as a substrate coating. The thermally conductive, corrosion resistant coating composition comprising a waterborne polyurethane polymer, and at least one additive. Other thermally conductive, corrosion resistant coating compositions also comprise thermally conductive particles.

### TECHNICAL FIELD

The disclosure generally relates to the field of substrate coatings. Particular embodiments relate to thermally conductive nanocomposite coating compositions that provide protection from the environment, including but not limited to, weathering, UV, chemicals, marine (salt), and solvents.

### BACKGROUND

Polymers, such as urethane-based polymers and polyurethane-based polymers, are frequently used as coatings. Such coatings provide not only aesthetics, but protection of the substrate from weather, UV, and the environment. However, such polymer coatings typically exhibit low thermal conductivity, poor thermal diffusivity, and can be less-than-ideal to protect the substrate from corrosion.

### SUMMARY OF THE DISCLOSURE

Several exemplary thermally conductive nanocomposite coating compositions are described herein, some of the exemplary coatings providing thermal conductivity as well as protection from the elements, in an environmentally-friendly, waterborne coating system.

Exemplary coating compositions preferably meet or exceed one or more of the following ASTM tests are met or exceeded with the novel coatings formulation; either by ASTM standards or best-in-class competition:
Adhesion: D3359 (Test Methods for Measuring Adhesion by Tape Test), D2197 Test Method for Adhesion of Organic Coatings by Scrape Adhesion
Density: D1475 Test Method For Density of Liquid Coatings, Inks, and Related Products
Drying Time D1640 Test Methods for Drying, Curing, or Film Formation of Organic Coatings at Room Temperature
Freeze-thaw stability: D2243 Test Method for Freeze-Thaw Resistance of Water-Borne Coatings
Heat stability of paint: D1849 Test Method for Package Stability of Paint ICI Cone & Plate viscosity: ASTM D4287
Low Temperature Coalescence D7306 Practice for Testing Low Temperature Film-Formation of Latex Paints by Visual Observation
Microbiological attack (mildew/algae): D3456 Practice for Determining by Exterior Exposure Tests the Susceptibility of Paint Films to Microbiological Attack
Salt fog resistance: ASTM B117-11 Standard Practice for Operating Salt Spray (Fog) Apparatus
Salt fog (modified) Resistance: ASTM G85-11 Standard Practice for Modified Salt Spray (Fog) Testing
Settling: D869 Test Method for Evaluating Degree of Settling of Paint
Thermal Conductivity: ASTM C518-10 Standard Test Method for Steady-State Thermal Transmission Properties by Means of the Heat Flow Meter Apparatus
Thermal Cycling: ASTM D6944-09 Standard Practice for Resistance of Cured Coatings to Thermal Cycling
Viscosity: D562 Test Method for Consistency of Paints Measuring Krebs Unit (KU) Viscosity Using a Stormer-Type Viscometer
Volatile Organic Content: D2369 Test Method for Volatile Content of Coatings D3960 Practice for Determining Volatile Organic Compound (VOC) Content of Paints and Related Coatings
Water Resistance: ASTM D2247-11 Standard Practice for Testing Water Resistance of Coatings in 100% Relative Humidity

### Definitions

The use of “e.g.,” “etc,” “for instance,” “in example,” “for example,” and “or” and grammatically related terms indicates non-exclusive alternatives without limitation, unless otherwise noted. The use of “including” and grammatically related terms means “including, but not limited to,” unless otherwise noted. The use of the articles “a,” “an” and “the” are meant to be interpreted as referring to the singular as well as the plural, unless the context clearly dictates otherwise. Thus, for example, reference to “an additive” includes two or more such additives, and the like. The use of “optionally,” “alternatively,” and grammatically related terms means that the subsequently described element, event or circumstance may or may not be present/occur, and that the description includes instances where said element, event or circumstance occurs and instances where it does not. The use of “preferred,” “preferably,” and grammatically related terms means that a specified element or technique is more acceptable than another, but not that such specified element or technique is a necessity, unless the context clearly dictates otherwise. The use of “exemplary”means “an example of” and is not intended to convey a meaning of an ideal or preferred embodiment.

The use of “substrate” means “a material having a surface,” unless the context clearly dictates otherwise. Exemplary substrates comprise corrodible surfaces utilized to transmit heat, including but not limited to condensing coils on window air conditioners, refrigerators, chillers, heaters, radiators, HVAC systems, etc. Typically, substrates are comprised of a conductive material such as copper, copper alloys, aluminum, and aluminum alloys. Frequently, substrates are located in outdoor, marine and industrial conditions, including corrosive environments subject to salty and/or acidic agents, and frequently can see temperature fluctuations exceeding 150° F. (65.6° C.) annually.

The use of “nanoparticle” means “a microscopic particle having at least one dimension of 100 nanometers (nm) or less,” unless the context clearly dictates otherwise. Nanoparticle shapes include, but are not limited to, nanospheres, nanotubes (buckytube), megatubes, nano-onions, buckyballs and buckyball clusters, and fullerene rings. Examples of nanoparticles include, but are not limited to, fullerenes (e.g., graphene nanoparticles, carbon nanotubes, single-walled carbon nanotubes, Buckminsterfullerene), and metal nanospheres. The nanoparticles provide thermal reservoirs within the composition, allowing a higher specific heat (meaning that the nanocomposite is more resistant to temperature change, allowing temperature differentials to remain constant). Exemplary formulations can comprise 0-3% nanoparticles, preferably 0-2%, more preferably 0.8%.

The use of “fullerene” means “any molecule composed entirely of carbon, in the form of a hollow sphere, ellipsoid or tube, including but not limited to carbon nanotubes” unless the context clearly dictates otherwise.

The use of “carbon nanotube” means “an allotrope of carbon with a cylindrical nanostructure,” unless the context clearly dictates otherwise. Carbon nanotubes are excellent thermal conductors along their long axis, and are typically poor conductors through their diameters. Randomly dispersed carbon nanotubes provide photon “shortcuts”, allowing thermal energy to transverse the composition hundreds of times better than as through a polymer alone. In exemplary compositions, the carbon nanotubes comprises industrial grade, multi-walled carbon nanotubes of diameter 5.0 nanometers (nm) to 50.0 nm, and a length of 10.0 micrometer (μm) to 250.0 μm. In other exemplary compositions, single-walled carbon nanotubes could be utilized, as could modified grapheme, or other fullerenes.

The use of “metal nanosphere” means a spherical nanoparticle formed of metal particles and/or metal oxide particles, unless the context clearly dictates otherwise. Exemplary metals include, but are not limited to, gold, silver, iron, platinum, and copper. Exemplary metal-oxides include, but are not limited to, copper oxide, zinc oxide, and titanium oxide.

### DETAILED DESCRIPTION

The following description and the referenced drawings provide illustrative examples of that which the inventor regards as their invention. As such, the embodiments discussed herein are merely exemplary in nature and are not intended to limit the scope of the invention, or its protection, in any manner. Rather, the description and illustration of these embodiments serve to enable a person of ordinary skill in the relevant art to practice the invention.

The inventive concepts disclosed herein are thermally conductive coating compositions comprising a waterborne polyurethane polymer, and at least one additive. More preferably, the inventive concepts disclosed herein are thermally conductive coating compositions comprising a waterborne polyurethane polymer, at least one additive, and at least one thermally conductive particle. The composition providing a coating which is resistant to corrosion, water, oxygen, acids and salts, and which enhances cooling performance and thermal conductivity, particularly for heat exchange equipment.

In one or more of the exemplary composition formulations, the waterborne polyurethane polymer comprises urethane.

In one or more of the exemplary composition formulations, the waterborne polyurethane polymer comprises waterborne aliphatic polyurethane dispersion (PUD). A PUD is a liquid polymer which can form a continuous film via evaporation of water. Examples of PUDs include, but are not limited to BAYHYDROL™ UH 2557 manufactured by Bayer Material Sciences, and NEOREZ™ R9045 manufactured by DSM.

In one or more of the exemplary composition formulations, the additive comprises one or more thinning agents, a powdered or liquefied pigment, and/or a chemical surfactant.

Examples of pigments include, but are not limited to, carbon black, titanium dioxide, mica, silicas, silicates, and organic and inorganic pigments for color matching. Examples of chemical surfactants include, but are not limited to those produced by Ethox Chemicals, LLC under the brand name E-SPERSE 131, and by BYK Atlanta under the brand name DISPERBYK®-2155. Exemplary formulations can comprise 0-5% of the additive(s), preferably 1-2% of the additive(s), more preferably 1% of the additive(s).

In one or more of the exemplary composition formulations, a skilled artisan knowledgeable in the art of paint formulation will be able to select an appropriate additive in a particular embodiment based on various considerations, including the intended use of the coating composition, the intended arena within which the coating composition will be used, and the equipment and/or accessories with which the coating composition is intended to be used, among other considerations, including for use as an industrial paint for aluminum and copper substrates that provide corrosion and weathering protection as well as thermal conductivity.

In one or more of the exemplary composition formulations, the thermally conductive particles comprise carbonaceous nanoparticles. The carbonaceous nanoparticles can comprise carbon nanoplatelets, and/or carbon nanotubes.

In one or more of the exemplary composition formulations, the thermally conductive particles comprise one or more of: aluminum trihydrate (ATH), micaceous iron oxide (MIOX), conductive carbon black, wollastonite (CaSiO₃), surface-treated carbon fibers, and other macro-sized particles that are thermally conductive.

In one or more of the exemplary composition formulations, the thermally conductive particles comprise one or more of: copper, silver, nickel, aluminum, gold, magnesium and other metal alloys that are thermally conductive.

In one or more of the exemplary composition formulations, the composition can comprise 25% to less than 75% by weight urethane, more than 4% and less than 10% carbonaceous nanomaterial, and water 5% to 50%. In one or more of the exemplary composition formulations, the composition can further comprise about 0-15% of a thermally-conductive, non-carbonaceous pigment.

In one or more of the exemplary composition formulations, the waterborne polyurethane polymer can comprise an aliphatic polyurethane resin synthesized from either H₁₂MDI (4,4′-Methylene dicyclohexyl diisocyanate), or IPDI (isophorone diisocyanate), or a blend of the two 1%:99% to 99%:1%.

In one or more of the exemplary composition formulations, the additive(s) can comprise at least one coalescing solvent to provide a minimum film forming temperature of 50° F. (10° C.). Suitable coalescing solvents include, but are not limited to: dipropylene glycol n-butyl ether (DPnB), dipropylene glycol methyl ether (DPM), propylene glycol methyl ether (PGME), propylene glycol, 2-butoxyethanol (butyl cellosolve), trimethyl pentanediol monoisobutyrate (TEXANOL™), and tripropylene glycol n-butyl ether (TPnB). One example of a PGME is DOWANOL® PM produced by The Dow Chemical Company. One example of a TPnB is DOWANOL® TPnB produced by The Dow Chemical Company. One example of a DPnB is DOWANOL® DPnB produced by The Dow Chemical Company.

In one or more of the exemplary composition formulations, the additive(s) can comprise one or more plasticizers. Suitable plasticizers include, but are not limited to: N-methyl pyrollidone (NMP), phthalates, Bis(2-ethylhexyl)-1,4-benzenedicarboxylate, and dimethoxymethyl phosphine oxide.

In one or more of the exemplary composition formulations, the additives can comprise cross-linking agents. Suitable cross-linking agents include, but are not limited to, polyfunctional aziridine crosslinking agents, carbodiimide, 3-Isocyanatopropyltriethoxysilane, 3-Glycidoxypropyltrimethoxysilane, 3-Glycidoxypropyltriethoxysilane, 3-Glycidoxypropylmethyldiethoxysilane, [2-(3,4-epoxycyclohexyl)ethyl]trimethoxysilane, and [2-(3,4-Epoxycyclohexyl)ethyl]trimethoxysilane.

In one or more of the exemplary composition formulations, the additives can comprise corrosion inhibitors specific to use on aluminum, copper and/or alloys thereof. Preferred corrosion inhibitors include those that do not contain hexavalent chromium (Cr⁺⁶), including but not limited to WPC Technologies HYBRICOR® 204, 294 and 2000, as well as Halox® Z-Plex 250, 430 JM and SZP-391 JM among others.

In one or more of the exemplary composition formulations, the additives can comprise one or more algaecides/mildewcides for the prevention of algae and mildew on the coated surfaces, for instance those with chemistries based on zinc (e.g., zinc 2-pyridinethiol-1-oxide (zinc omadine, zinc pyrithione), dimethylaminoethanol, 2-bromo-2-nitropropane-1,3-diol, methylchloroisothiazolinone (5-chloro-2-methyl-4-isothiazolin-3-one), and methylisothiazolinone (2-Methyl-4-isothiazolin-3-one).

The exemplary composition formulations allowing for environmental protection of a substrate while retaining a maximum magnitude of thermal conductivity. The exemplary nanocomposite coating compositions can be utilized as an anti-corrosion coating (environmental protection) that exhibits moderately high thermal conductivity qualities, moderately high thermal diffusivity qualities, moderately high specific heat values, and inherent anti-microbial/anti-fouling characteristics

### Formulation Examples

One exemplary thermally conductive coating composition comprises one or more of: a waterborne aliphatic polyurethane dispersion, a cross-linking agent, a coalescing solvent, fullerene nanoparticles, thermally conductive particles, at least one algaecide/mildewcide, a pigment, and a corrosion inhibitor.

Another exemplary thermally conductive coating composition comprises: a waterborne aliphatic polyurethane dispersion, a polyfunctional aziridine crosslinking agent, propylene glycol methyl ether, tripropylene glycol n-butyl ether, fullerene nanoparticles, micaceous iron oxide, zinc 2-pyridinethiol-1-oxide, Ethox E-SPERSE 131, and HYBRICOR® 204.

In another alternative composition, the composition comprises: a waterborne aliphatic polyurethane dispersion, a carboiimide cross-linker, propylene glycol methyl ether, tripropylene glycol n-butyl ether, graphene nanoparticles, micaceous iron oxide, zinc 2-pyridinethiol-1-oxide, Ethox E-SPERSE® 131, and HYBRICOR® 204.

In another alternative composition, the composition comprises: waterborne aliphatic polyurethane dispersion, polyaziridine cross-linker, propylene glycol methyl ether, tripropylene glycol n-butyl ether, graphene nanoparticles, wollastonite, aluminum trihydrate, zinc 2-pyridinethiol-1-oxide, Ethox E-SPERSE® 131, and HYBRICOR® 204.

In another alternative composition, the composition comprises: waterborne aliphatic polyurethane dispersion, polyaziridine cross-linker, propylene glycol methyl ether, tripropylene glycol n-butyl ether, graphene nanoparticles, micaceous iron oxide, zinc 2-pyridinethiol-1-oxide, Ethox E-SPERSE® 131, and HYBRICOR® 204.

In another alternative composition, the composition comprises: waterborne aliphatic polyurethane dispersion, polyaziridine cross-linker, propylene glycol methyl ether, tripropylene glycol n-butyl ether, single-walled carbon nanotubes, micaceous iron oxide, 2-bromo-2-nitropropane-1,3-diol, Ethox E-SPERSE® 131, and HYBRICOR® 204.

In another alternative composition, the composition comprises: waterborne aliphatic polyurethane dispersion, carboiimide cross-linker, propylene glycol methyl ether, dipropylene glycol n-butyl ether, single-walled carbon nanotubes, wollastonite, zinc 2-pyridinethiol-1-oxide, Ethox E-SPERSE® 131, and Halox® SZP-391 JM.

In another alternative composition, the composition comprises: waterborne aliphatic polyurethane dispersion, carboiimide cross-linker, propylene glycol methyl ether, tripropylene glycol n-butyl ether, single-walled carbon nanotubes, wollastonite, zinc 2-pyridinethiol-1-oxide, Ethox E-SPERSE® 131, and Halox® Z-Plex 250.

In another alternative composition, the composition comprises: waterborne aliphatic polyurethane dispersion, 3-Glycidoxypropyltrimethoxysilane, propylene glycol methyl ether, tripropylene glycol n-butyl ether, single-walled carbon nanotubes, wollastonite, zinc 2-pyridinethiol-1-oxide, Ethox E-SPERSE® 131, and Halox® Z-Plex 250.

In another alternative composition, the composition comprises: waterborne aliphatic polyurethane dispersion, 3-Glycidoxypropylmethyldiethoxysilane, propylene glycol methyl ether, tripropylene glycol n-butyl ether, single-walled carbon nanotubes, wollastonite, zinc 2-pyridinethiol-1-oxide, Ethox E-SPERSE® 131, and Halox® Z-Plex 250.

In another alternative composition, the composition comprises: waterborne aliphatic polyurethane dispersion, 2-(3,4-epoxycyclohexyl) ethyltrimethoxysilane, propylene glycol methyl ether, tripropylene glycol n-butyl ether, single-walled carbon nanotubes, wollastonite, zinc 2-pyridinethiol-1-oxide, Ethox E-SPERSE® 131, and Halox® Z-Plex 250.

In another alternative composition, the composition comprises: waterborne aliphatic polyurethane dispersion, (3,4-epoxycyclohexyl) ethyltriethoxysilane, propylene glycol methyl ether, tripropylene glycol n-butyl ether, single-walled carbon nanotubes, wollastonite, 5-Chloro-2-methyl-4-isothiazolin-3-one, Ethox E-SPERSE® 131, and Halox® Z-Plex 250.

Any application process (e.g., spraying, dipping, flooding) can be utilized to apply the nanocomposite coating composition to the surface of a substrate, and a skilled artisan will be able to select an appropriate application process and equipment for the exemplary composition in a particular embodiment based on various considerations, including the intended use of the exemplary composition, the intended arena within which the exemplary composition will be used, the environmental conditions, the type of the substrate, the location of the substrate, and the equipment and/or accessories with which the exemplary composition is intended to be used, among other considerations. It is preferred that the nanocomposite coating composition be applied in any thickness. Specifically, applying the wet nanocomposite coating composition at 3.5-5.0 mil (one mil=one-thousandths of an inch) 1.2-1.7 mils dry to the surface of the substrate, and results in an excellent thermally conductive corrosion inhibitive coating.

Any suitable structure and material and/or chemical compound can be used in the exemplary compositions, and a skilled artisan will be able to select an appropriate structure and material for the exemplary composition in a particular embodiment based on various considerations, including the intended use of the exemplary composition, the intended arena within which the exemplary composition will be used, and the equipment and/or accessories with which the exemplary composition is intended to be used, among other considerations.

It is noted that all structures, features and components of the various described and illustrated embodiments can be combined in any suitable configuration for inclusion in an exemplary composition according to a particular embodiment.

The foregoing detailed description provides exemplary embodiments of the invention and includes the best mode for practicing the invention. The description and illustration of these embodiments is intended only to provide examples of the invention, and not to limit the scope of the invention, or its protection, in any manner.

What is claimed is:

1. A thermally conductive coating composition comprising a waterborne polyurethane polymer, and at least one additive.

2. The thermally conductive coating composition of claim 1, wherein said at least one additive comprises at least one thinning agent.

3. The thermally conductive coating composition of claim 1, wherein the waterborne polyurethane polymer comprises urethane.

4. The thermally conductive coating composition of claim 1, wherein the waterborne polyurethane polymer comprises a waterborne aliphatic polyurethane dispersion.

5. The thermally conductive coating composition of claim 1, wherein said at least one additive comprises at least one pigment.

6. The thermally conductive coating composition of claim 5, wherein said pigments comprise at least one of carbon black, titanium dioxide, mica, silicas, silicates, and organic and inorganic pigments.

7. The thermally conductive coating composition of claim 1, further comprising at least one thermally conductive particle.

8. The thermally conductive coating composition of claim 7, wherein said thermally conductive particles comprise carbonaceous nanoparticles.

9. The thermally conductive coating composition of claim 8, wherein said carbonaceous nanoparticles comprise carbon nanoplatelets.

10. The thermally conductive coating composition of claim 8, wherein said carbonaceous nanoparticles comprise carbon nanotubes.

11. The thermally conductive coating composition of claim 7, wherein said thermally conductive particles comprise one or more of: aluminum trihydrate (ATH), micaceous iron oxide (MIOX), conductive carbon black, wollastonite (CaSiO₃), surface-treated carbon fibers, and other macro-sized particles that are thermally conductive.

12. The thermally conductive coating composition of claim 7, wherein said thermally conductive particles comprise one or more of: copper, silver, nickel, aluminum, gold, magnesium and other metal alloys that are thermally conductive.

13. The thermally conductive coating composition of claim 1, further comprising at least one thermally conductive particle, wherein the waterborne polyurethane polymer comprises urethane, wherein said at least one thermally conductive particle comprises carbonaceous nanoparticles, and wherein said composition comprises 25% to less than 75% by weight urethane, more than 4% and less than 10% carbonaceous nanomaterial, and 5% to 50% water.

14. The thermally conductive coating composition of claim 1, further comprising about 0-15% of a thermally-conductive, non-carbonaceous pigment.

15. The thermally conductive coating composition of claim 1, wherein said waterborne polyurethane polymer comprises an aliphatic polyurethane resin synthesized from either H₁₂MDI (4,4′-Methylene dicyclohexyl diisocyanate), or IPDI (isophorone diisocyanate), or a blend of the two.

16. The thermally conductive coating composition of claim 1, wherein said additive comprises at least one additive selected from the group consisting of coalescing solvents, plasticizers, cross-linking agents, corrosion inhibitors, algaecides, and mildewcides.

17. The thermally conductive coating composition of claim 1, wherein said at least one additive comprises at least one chemical surfactant.

18. The thermally conductive coating composition of claim 17, wherein said chemical surfactant comprises at least one of Ethox E-SPERSE 131 and BYK Atlanta DISPERBYK®-2155.

19. A thermally conductive coating composition comprising one or more of: a waterborne aliphatic polyurethane dispersion, a cross-linking agent, a coalescing solvent, fullerene nanoparticles, thermally conductive particles, at least one algaecide/mildewcide, a pigment, and a corrosion inhibitor.

20. A thermally conductive coating composition comprising a waterborne aliphatic polyurethane dispersion, a polyfunctional aziridine crosslinking agent, propylene glycol methyl ether, tripropylene glycol n-butyl ether, fullerene nanoparticles, micaceous iron oxide, zinc 2-pyridinethiol-1-oxide, Ethox E-SPERSE 131, and HYBRICOR® 204.
